(19) United States
(12) Patent Application Publication
(10) Pub. No.: US 2013/0225770 A1
(43) Pub. Date: Aug. 29, 2013

(54) Polyamide Resin

(71) Applicant: Cheil Industries Inc., (US)

(72) Inventors: Seung Hyun JANG, Uiwang-si (KR); Young Sub JIN, Uiwang-si (KR); So Young KWON, Uiwang-si (KR); Sang Kyun IM, Uiwang-si (KR); Myung Ryul LEE, Uiwang-si (KR); Bok Nam JANG, Uiwang-si (KR); Yong Tae KIM, Uiwang-si (KR)

(73) Assignee: Cheil Industries Inc., Gumi-si (KR)

(21) Appl. No.: 13/862,665

(22) Filed: Apr. 15, 2013

Related U.S. Application Data
(63) Continuation-in-part of application No. PCT/KR2010/009535, filed on Dec. 29, 2010.

(30) Foreign Application Priority Data
Oct. 18, 2010 (KR) 10-2010-0101595

(51) Int. Cl. C08G 69/26

(52) U.S. Cl. CPC C08G 69/26
USPC 525/435; 528/338

(57) ABSTRACT

A polyamide resin is a polymer comprising (A) aliphatic diamine; and (B) dicarboxylic acid, wherein the (A) aliphatic diamine includes (a1) a first aliphatic diamine monomer including a C4, C6, C8 or C10 aliphatic diamine or a combination thereof, and (a2) a second aliphatic diamine monomer including a C12, C14, C16 or C18 aliphatic diamine or a combination thereof. The polymer can have good melt processability, low absorbency, and/or excellent brightness.

### CROSS-REFERENCE TO RELATED APPLICATIONS

This application is a continuation-in-part of International Application No. PCT/KR2010/009535 filed on Dec. 29, 2010, pending, which designates the U.S., published as WO 2012/053699, and is incorporated herein by reference in its entirety, and claims priority therefrom under 35 USC Section 120. This application also claims priority under 35 USC Section 119 to and the benefit of Korean Patent Application No. 10-2010-0101595 filed on Oct. 18, 2010, the entire disclosure of which is incorporated herein by reference.

### FIELD OF THE INVENTION

The present invention relates to a polyamide resin that can have excellent melt processability, low water absorptivity and excellent brightness.

### BACKGROUND OF THE INVENTION

Nylon 66 and nylon 6 are well known polyamide resins. These aliphatic polyamides are widely used in automobile components, electric and electronic products, mechanical parts, and the like. However, aliphatic polyamides do not have sufficient thermal stability to be employed in fields requiring high heat resistance.

Aromatic polyamides have higher melting temperature and heat resistance than aliphatic polyamides. However, due to their high melting point, aromatic polyamides can have restricted processibility.

US Patent Publication No. 2009/0054620 discloses the preparation of meta-type polyamine resins through reaction of m-phenylenediamine and isophthalic chloride to improve melt processability of meta-type polyamide resins over para-type polyamides. However, processability may not be sufficiently improved due to the high melting point of the aromatic polyamide resins.

U.S. Pat. No. 5,102,935 discloses some attempts to improve melt processability by copolymerizing polyamides and oligomer esters. However, the copolymers can have a disadvantage in that the main chain of the copolymer can be degraded by hydrolysis of an oligomer ester group, causing deterioration in thermal stability. US Patent Publication No. 2008/0249238 discloses a method for improving melt processability by adding plasticizers to polyamide resins. However, such a method can result in deterioration in thermal and mechanical properties.

Japanese Patent Laid-Open Publication No. 2002/293926 discloses polyamides having improved moldability, low water absorptivity (absorption), chemical resistance, strength and heat resistance by employing 1,10-diaminodecane as a diamine component. However, although such a method can improve chemical resistance and heat resistance to some degree, the method allows only slight increase in flowability and water absorptivity and no improvement in brightness.

Currently, although various attempts have been made to improve moldability and water absorptivity, polyamide resins developed up to now show slight increase in water absorptivity and have some problems in terms of brightness of final molded articles. Specifically, in order for the polyamide resins to be employed in products such as LED reflectors or plastic joint parts, the polyamide resins require high brightness.

Therefore, there is a need for polyamide resins having not only excellent processability, heat resistance, mechanical strength and low water absorptivity, but also excellent brightness.

### SUMMARY OF THE INVENTION

The present invention provides a polyamide resin that not only can have excellent melt processability and low water absorptivity but also excellent brightness. The polyamide resin can also have an excellent balance of physical properties, such as melt processability, heat resistance, mechanical strength, low water absorptivity, brightness, and the like. Further, the polyamide resin can have an excellent appearance and color realization.

The polyamide resin can have an intrinsic viscosity of about 0.3 dL/g to about 4.0 dL/g.

The polyamide resin can be useful in an LED reflector requiring high brightness.

More particularly, the present invention relates to a polyamide resin that can have excellent processability, heat resistance, low water absorptivity and improved brightness by employing two kinds of aliphatic diamines having a specific number of carbon atoms.

In accordance with the present invention, a polyamide resin comprises a polymer of (A) an aliphatic diamine and (B) a dicarboxylic acid. The (A) aliphatic diamine comprises (a1) a first aliphatic diamine monomer comprising a C4, C6, C8, and/or C10 aliphatic diamine and (a2) a second aliphatic diamine monomer comprising a C12, C14, C16 and/or C18 aliphatic diamine.

In one embodiment, the (a2) second aliphatic diamine monomer may be present in an amount of about 0.1 mol % to about 70 mol % based on the total amount (100 mol %) of the aliphatic diamine monomers of the aliphatic diamine (A). In another embodiment, the (a2) second aliphatic diamine monomer may be present in an amount of about 2 mol % to about 50 mol % based on the total amount (100 mol %) of the aliphatic diamine monomers of the aliphatic diamine (A).

In one embodiment, a mole ratio of the total mole of the (a1) first aliphatic diamine monomer and the (a2) second aliphatic diamine monomer to the total mole of the (B) dicarboxylic acid monomer, (a1+a2)/(B), may range from about 0.90 to about 1.30.

In one embodiment, the (a1) first aliphatic diamine monomer may be 1,10-decanediamine, and the (a2) second aliphatic diamine monomer may be 1,12-dodecanediamine.

In one embodiment, at least one of the (a1) first aliphatic diamine monomer and the (a2) second aliphatic diamine monomer may be a branched alkyl group.

In another embodiment, both the (a1) first aliphatic diamine monomer and the (a2) second aliphatic diamine monomer may include a linear alkyl group.

In one embodiment, the (B) dicarboxylic acid may include an aromatic dicarboxylic acid.

Examples of the (B) dicarboxylic acid may include without limitation terephthalic acid, isophthalic acid, 2,6-naphthalene dicarboxylic acid, 2,7-naphthalene dicarboxylic acid, 1,4-naphthalene dicarboxylic acid, 1,4-phenylene dioxyphenylene acid, 1,3-phenylenedioxy-diacetic acid, diphenic acid, 4,4′-oxybis(benzoic acid), diphenylmethane-4,4′-dicarboxylic acid, diphenylsulfone-4,4′dicarboxylic acid, 4,4′-diphenylcarboxylic acid, and the like, and combinations thereof.

In another embodiment, the (B) dicarboxylic acid may be a mixture of an aromatic dicarboxylic acid and an aliphatic dicarboxylic acid.

The polyamide resin may have an end group capped with an end capping agent. Examples of the end capping agent may include without limitation aliphatic carboxylic acids, aromatic carboxylic acids, and the like, and combinations thereof.

Examples of the end capping agent may include without limitation acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, a-naphthalene carboxylic acid, β-naphthalene carboxylic acid, methylnaphthalene carboxylic acid, and the like, and combinations thereof.

The polyamide resin may have an intrinsic viscosity at 25° C. of about 0.3 dL/g to about 4.0 dL/g in 98% sulfuric acid solution at 25° C. as measured using an Ubbelohde viscometer.

A ratio of tensile strength of the polyamide resin after treatment at 80° C. and 95% relative humidity (RH) for 24 hours to tensile strength thereof before treatment at 80° C. and 95% RH for 24 hours may be about 89% or more, and a water absorption rate of the polyamide resin after treatment at 80° C. and 80% RH for 48 hours may be about 0.9% or less.

The polyamide resin according to the present invention can be suitable for LED reflectors and plastic joints for automobile components, which can require excellent appearance, excellent color realization, and excellent balance of physical properties, such as processability, heat resistance, mechanical strength, low water absorptivity and brightness.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The polyamide resin of the present invention is a polymer comprising (A) an aliphatic diamine; and (B) a dicarboxylic acid, wherein the (A) aliphatic diamine includes two or more different aliphatic diamine monomers (a1, a2). Both the (a1) first aliphatic diamine monomer and the (a2) second aliphatic diamine monomer can include an even number of carbon atoms, which can lead to much higher heat resistance than the combination of even number-odd number of carbon atoms or odd number-odd number of carbon atoms. In one embodiment, the (A) aliphatic diamine comprises (a1) a first aliphatic diamine monomer comprising a C4, C6, C8, or C10 aliphatic diamine or a combination thereof and (a2) a second aliphatic diamine monomer comprising a C12, C14, C16, or C18 aliphatic diamine or a combination thereof.

The second aliphatic diamine monomer is more flexible than the first aliphatic diamine monomer, which can improve melt processability.

In one embodiment, the aliphatic diamine (A) can include the (a2) second aliphatic diamine monomer in an amount of about 0.1 mol % to about 70 mol %, for example about 1 mol % to about 65 mol %, as another example about 2 mol % to about 50 mol %, and as another example about 30 mol % to about 60 mol %, based on the total amount (100 mol %) of the diamine monomers of the aliphatic diamine (A).

In some embodiments, the second aliphatic diamine monomer (a2) may be present in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 mol %. Further, according to some embodiments of the present invention, the amount of second aliphatic diamine monomer (a2) can be in a range from about any of the foregoing amounts to about any other of the foregoing amounts.

When the aliphatic diamine (A) includes the (a2) second aliphatic diamine monomer in an amount within this range, the resin may have a balance of physical properties such as processability and mechanical strength.

Examples of the (a1) first aliphatic diamine monomer may include without limitation 1,4-butanediamine, 1,6-hexanediamine, 1,8-octanediamine, 1,10-decanediamine, and the like. These may be used alone or in combination of two or more thereof. In exemplary embodiments, the polyamide resin includes 1,10-decanediamine as the first aliphatic diamine monomer.

Examples of the (a2) second aliphatic diamine monomer may include without limitation 1,12-dodecanediamine, 1,14-tetradecanediamine, 1,16-hexadecanediamine, 1,18-octadecanediamine, and the like. These may be used alone or in combination of two or more thereof. In exemplary embodiments, the polyamide resin includes 1,12-dodecanediamine as the second aliphatic diamine monomer.

In exemplary embodiments, the aliphatic diamine is a combination of 1,10-decanediamine as the (a1) first aliphatic diamine monomer and 1,12-dodecanediamine as the (a2) second aliphatic diamine monomer. This combination can provide excellent heat resistance, low water absorptivity, excellent mechanical strength, excellent flowability, and/or high brightness.

In one embodiment, at least one of the (a1) first aliphatic diamine monomer and the (a2) second aliphatic diamine monomer may be a branched alkyl group. When containing such a branched alkyl group, the polyamide resin may have further improved processability.

In another embodiment, both the (a1) first aliphatic diamine monomer and the (a2) second aliphatic diamine monomer may include a linear alkyl group.

The (B) dicarboxylic acid may include an aromatic dicarboxylic acid. The present invention may accomplish satisfactory properties in terms of melt processability, heat resistance and low water absorptivity by employing two or more kinds of aliphatic diamines having a specific number of carbon atoms together with an aromatic dicarboxylic acid.

In one embodiment, the (B) dicarboxylic acid may include at least one aromatic dicarboxylic acid. In another embodiment, the (B) dicarboxylic acid may be a mixture of an aromatic dicarboxylic acid and an aliphatic dicarboxylic acid.

Examples of the aromatic dicarboxylic acid may include without limitation terephthalic acid, isophthalic acid, 2,6-naphthalene dicarboxylic acid, 2,7-naphthalene dicarboxylic acid, 1,4-naphthalene dicarboxylic acid, 1,4-phenylene dioxyphenylene acid, 1,3-phenylenedioxy-diacetic acid, diphenic acid, 4,4′-oxybis(benzoic acid), diphenylmethane-4,4′-dicarboxylic acid, diphenylsulfone-4,4′-dicarboxylic acid, 4,4′-diphenylcarboxylic acid, and the like. These may be used alone or in combination of two or more thereof.

Examples of the aliphatic dicarboxylic acid may include without limitation adipic acid, heptane dicarboxylic acid, octane dicarboxylic acid, azelaic acid, nonane dicarboxylic acid, sebacic acid, dodecane dicarboxylic acid, and the like. These may be used alone or in combination of two or more thereof. In exemplary embodiments, adipic acid is used.

In one embodiment, a mole ratio of the total moles of the (a1) first aliphatic diamine monomer and the (a2) second aliphatic diamine monomer to the total moles of the (B) dicarboxylic acid monomer, (a1+a2)/(B), may range from about 0.90 to about 1.30, for example about 0.95 to about 1.2. Within this range, the polyamide resin can have a good balance of flowability and mechanical strength and/or low water absorptivity may be obtained.

The polyamide resin of the present invention may be produced through polycondensation of the (B) dicarboxylic acid with the aliphatic diamine monomers (al, a2) having isomorphous structures.

In one embodiment, the (A) aliphatic diamine obtained by mixing the (a1) aliphatic diamine monomer and the (a2) aliphatic diamine monomer, and the (B) dicarboxylic acid are placed in a reactor, and then stirred at a temperature of about 80 to about 120° C. for about 0.5 to about 2 hours. Then, the temperature is increased up to about 200 to about 280° C. and maintained for about 2 to about 4 hours, and the pressure is initially maintained at about 20 to about 40 kgf/cm² and then decreased to about 10 to about 20 kgf/cm², followed by reaction for about 1 to about 3 hours. The resultant polyamide is subjected to solid polymerization at temperatures between the glass transition temperature (Tg) and the melting temperature (Tm) thereof in a vacuum for about 10 to about 30 hours to obtain a final reactant.

In one embodiment, when the (A) aliphatic diamine and the (B) dicarboxylic acid are provided to the reactor, an end capping agent may be used. Further, the viscosity of a synthesized copolymer resin may be adjusted by adjusting the amount of end capping agent. The end capping agent may be an aliphatic carboxylic acid and/or an aromatic carboxylic acid.

Examples of the end capping agent may include without limitation acetic acid, propionic acid, butyric acid, valeric acid, caproic acid, caprilic acid, lauric acid, tridecanoic acid, myristic acid, palmitic acid, stearic acid, pivalic acid, isobutyric acid, benzoic acid, toluic acid, a-naphthalene carboxylic acid, β-naphthalene carboxylic acid, methylnaphthalene carboxylic acid, and the like. These may be used alone or in combination of two or more thereof.

In addition, a catalyst may be used in the reaction. In exemplary embodiments, a phosphorus type catalyst is used. Examples of phosphorous catalysts can include without limitation phosphoric acid, phosphorus acid, hypophosphorus acid, salts and/or derivatives thereof, and the like, and combinations thereof, for example, phosphoric acid, phosphorus acid, hypophosphorus acid, sodium hypophosphate, sodium hypophosphite, and the like, and combinations thereof.

The catalyst used in the production of polyamide resin of the present invention may be present in an amount of about 0 wt % to about 3.0 wt %, for example about 0 wt % to about 1.0 wt %, and as another example about 0 wt % to about 0.5 wt %, based on the total weight of the monomers.

The polyamide resin of the present invention may have an L* value of about 92 or less, for example about 93 or less, as measured in accordance with ASTM D 1209. As such, the polyamide resin can have higher brightness than polyamide resins in the art, and thus can be advantageously used in the production of various products, such as but not limited to electric and electronic materials, such as LED reflectors, plastic joints of automobile components, and the like.

The polyamide resin may have an intrinsic viscosity of about 0.3 dL/g to about 4.0 dL/g, as measured using an Ubbelohde viscometer in 98% sulfuric acid solution at 25° C.

The ratio of tensile strength of the polyamide resin after treatment at 80° C. and 95% RH for 24 hours to tensile strength thereof before treatment at 80° C. and 95% RH for 24 hours can be about 89% or more, for example about 90% to about 99%. The water absorption rate of the polyamide resin after treatment at 80° C. and 80% RH for 48 hours can be about 0.9% or less, for example about 0.3% to about 0.8%.

Hereinafter, the present invention will be described in more detail with reference to examples. These examples are provided for illustration only and are not to be in any way construed as limiting the present invention.

### EXAMPLES

### Example 1

In a 1 liter autoclave, 0.6019 mol (100 g) of terephthalic acid, 0.553 mol (95.2 g) of 1,10-decanediamine, 0.061 mol (12.301 g) of 1,12-dodecanediamine, 0.024 mol (2.94 g) of benzoic acid, 0.1 wt % (0.21 g) of sodium hypophosphite, and 90 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.25 dL/g.

The polyamide pre-copolymer is subjected to solid state polymerization at 230° C. for 24 hours to obtain a final polyamide resin having an intrinsic viscosity of 1.14 dL/g.

### Example 2

In a 1 liter autoclave, 0.6019 mol (100 g) of terephthalic acid, 0.43 mol (74.1 g) of 1,10-decanediamine, 0.184 mol (36.9 g) of 1,12-dodecanediamine, 0.024 mol (2.94 g) of benzoic acid, 0.1 wt % (0.21 g) of sodium hypophosphite and 92 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.21 dL/g.

The obtained polyamide pre-copolymer is subjected to solid state polymerization at 230° C. for 24 hours to obtain a final polyamide resin having an intrinsic viscosity of 1.08 dL/g.

### Example 3

In a 1 liter autoclave, 0.6019 mol (100 g) of terephthalic acid, 0.307 mol (52.9 g) of 1,10-decanediamine, 0.307 mol (61.5 g) of 1,12-dodecanediamine, 0.024 mol (2.94 g) of benzoic acid, 0.1 wt % (0.22 g) of sodium hypophosphite and 93 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.15 dL/g.

The obtained polyamide pre-copolymer is subjected to solid state polymerization at 230° C. for 24 hours to obtain a final polyamide resin having an intrinsic viscosity of 1.01 dL/g.

### Example 4

In a 1 liter autoclave, 0.6019 mol (100g) of terephthalic acid, 0.06 mol (10 g) of isophthalic acid, 0.553 mol (95.2 g) of 1,10-decanediamine, 0.016 mol (12.30 g) of 1,12-dodecanediamine, 0.024 mol (2.94 g) of benzoic acid, 0.1 wt % (0.2 g) of sodium hypophosphite and 86 ml of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.12 dL/g.

The obtained polyamide pre-copolymer is subjected to solid state polymerization at 230° C. for 24 hours to obtain a final polyamide resin having an intrinsic viscosity of 0.98 dL/g.

Example 5

In a 1 liter autoclave, 0.6019 mol (100g) of terephthalic acid, 0.06 mol (8.8 g) of adipic acid, 0.553 mol (95.2 g) of 1,10-decanediamine, 0.016 mol (12.30 g) of 1,12-dodecanediamine, 0.024 mol (2.94 g) of benzoic acid, 0.1 wt % (0.2 g) of sodium hypophosphite and 86 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.11 dL/g.

The obtained polyamide pre-copolymer is subjected to solid state polymerization at 230° C. for 24 hours to obtain a final polyamide resin having an intrinsic viscosity of 0.96 dL/g.

### Example 6

In a 1 liter autoclave, 0.6019 mol (100g) of terephthalic acid, 0.547 mol (94.3 g) of 1,10-decanediamine, 0.061 mol (12.18 g) of 1,12-dodecanediamine, 0.1 wt % (0.21 g) of sodium hypophosphite, and 138 ml of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.2 dL/g.

The obtained polyamide pre-copolymer is subjected to solid state polymerization at 230° C. for 24 hours to obtain a final polyamide resin having an intrinsic viscosity of 1.43 dL/g.

### Example 7

In a 1 liter autoclave, 0.6019 mol (100 g) of terephthalic acid, 0.501 mol (86.3 g) of 1,10-decanediamine, 0.19 mol (25.1 g) of 1,12-dodecanediamine, 0.05 mol (5.88 g) of benzoic acid, 0.1 wt % (0.22 g) of sodium hypophosphite, and 55 mL of distilled water are placed and then the autoclave is purged with nitrogen. After stirring at 100° C. for 60 minutes and elevating the temperature to 250° C. for 2 hours, reaction is was carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.10 dL/g.

The obtained polyamide pre-copolymer is subjected to solid state polymerization at 230° C. for 24 hours to obtain a final polyamide resin having an intrinsic viscosity of 1.05 dL/g.

### Comparative Example 1

In a 1 liter autoclave, 0.6019 mol (100g) of terephthalic acid, 0.614 mol (102 g) of 1,10-decanediamine, 0.024 mol (2.94 g) of benzoic acid, 0.1 wt % (0.205 g) of sodium hypophosphite and 88 ml of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.25 dL/g.

The obtained polyamide pre-copolymer is subjected to solid state polymerization at 230° C. for 24 hours to obtain a final polyamide resin having an intrinsic viscosity of 1.3 dL/g.

### Comparative Example 2

In a 1 liter autoclave, 0.6019 mol (100g) of terephthalic acid, 0.184 mol (21.2 g) of 1,10-decanediamine, 0.43 mol (98.4 g) of 1,12-dodecanediamine, 0.024 mol (2.94 g) of benzoic acid, 0.1 wt % (0.22 g) of sodium hypophosphite, and 96 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.09 dL/g.

The obtained polyamide pre-copolymer is subjected to solid state polymerization at 230° C. for 24 hours to obtain a final polyamide resin having an intrinsic viscosity of 0.6 dL/g.

### Comparative Example 3

In a 1 liter autoclave, 0.6019 mol (100g) of terephthalic acid, 0.614 mol (7.14 g) of 1,6-hexamethylenediamine, 0.553 mol (110.7 g) of 1,12-dodecanediamine, 0.024 mol (2.94 g) of benzoic acid, 0.1 wt % (0.205 g) of sodium hypophosphite and 95 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.1 dL/g.

The obtained polyamide pre-copolymer is subjected to solid state polymerization at 230° C. for 24 hours to obtain a final polyamide resin having an intrinsic viscosity of 0.65 dL/g.

### Comparative Example 4

In a 1 liter autoclave, 0.6019 mol (100g) of terephthalic acid, 0.43 mol (74.05 g) of 1,10-decanediamine, 0.184 mol (21.4 g) of 1,6-heptanediamine, 0.024 mol (2.94 g) of benzoic acid, 0.1 wt % (0.198 g) of sodium hypophosphite, and 85 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.2 dL/g.

The obtained polyamide pre-copolymer is subjected to solid state polymerization at 230° C. for 24 hours to obtain a final polyamide resin having an intrinsic viscosity of 0.93 dL/g.

### Comparative Example 5

In a 1 liter autoclave, 0.6019 mol (100g) of terephthalic acid, 0.43 mol (74.05 g) of 1,10-decanediamine, 0.184 mol (21.4 g) of 1,9-nonanediamine, 0.024 mol (2.94 g) of benzoic acid, 0.1 wt % (0.21 g) of sodium hypophosphite and 88 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.12 dL/g.

The obtained polyamide pre-copolymer is subjected to solid state polymerization at 230° C. for 24 hours to obtain a final polyamide resin having an intrinsic viscosity of 0.84 dL/g.

### Comparative Example 6

In a 1 liter autoclave, 0.6019 mol (100 g) of terephthalic acid, 0.43 mol (74.05 g) of 1,10-decanediamine, 0.184 mol (34.32 g) of 1,11-undecanediamine, 0.024 mol (2.94 g) of benzoic acid, 0.1 wt % (0.21 g) of sodium hypophosphite and 91 mL of distilled water are placed and then the autoclave is purged with nitrogen. After stirring at 100° C. for 60 minutes and elevating the temperature to 250° C. for 2 hours, reaction is carried out at this temperature for 3 hours while maintaining the pressure at 25 kgf/cm². Then, the pressure is reduced to 15 kgf/cm² and reaction is carried out for 1 hour to prepare a polyamide pre-copolymer having an intrinsic viscosity of 0.18 dL/g.

The obtained polyamide pre-copolymer is subjected to solid state polymerization at 230° C. for 24 hours to obtain a final polyamide resin having an intrinsic viscosity of 0.88 dL/g.

The polyamide resin samples prepared in the examples and the comparative examples are evaluated as to physical properties such as thermal characteristics and intrinsic viscosity before and after solid state polymerization in accordance with the following methods.

(1) Melting temperature, crystallization temperature and thermal degradation temperature: The melting temperature, crystallization temperature and thermal degradation temperature are measured using a differential scanning calorimeter (DSC) and a thermogravimetric analyzer (TGA) (unit: ° C.).

(2) Intrinsic viscosity: The obtained polyamide is dissolved in a concentrated sulfuric acid solution (96%) and then intrinsic viscosity is measured at 25° C. using Ubbelohde viscometer (unit: dL/g).

(3) Flowability: Flowability is measured using a Sumitomo injection molding machine SG75H-MIV. The temperatures of the cylinder and the molding machine are set to 320° C. and pressure for injection molding is set to 15 MPa (unit: mm).

(4) Strength retention rate: Tensile strength is measured in accordance with ISO 527 (23° C., 5 mm/min). Strength retention rate is determined by calculating the ratio of the tensile strength of the sample after treatment in a thermo-hygrostat at 80° C. and 95% RH for 24 hours to the tensile strength of the sample before treatment at 80° C. and 95% RH for 24 hours.

(5) Water absorption rate: Samples having a length of 100 mm, width of 100 mm and thickness of 3 mm are prepared and dried. The weight of each dried sample is measured (W₀) and after treating the sample in a thermo-hygrostat at 80° C. and 80% RH for 48 hours, the weight of the sample (W₁) is measured.

water absorption rate (%)=[(W₁−W₀)/W₀]*100

(6) Brightness: L* value is measured using a colorimeter based on ASTM D 1209 standards.

Results of Examples 1 to 7 and Comparative Examples 1 to 6 are shown in Tables 1 and 2, respectively.

TABLE 1

| | Example | | | | | | |
|---|---|---|---|---|---|---|---|
| | 1 | 2 | 3 | 4 | 5 | 6 | 7 |
| Melting temperature | 310 | 305 | 300 | 301 | 304 | 311 | 300 |
| (° C.) | | | | | | | |
| Crystallization | 280 | 273 | 270 | 271 | 274 | 278 | 275 |
| temperature (° C.) | | | | | | | |
| Thermal degradation | 453 | 452 | 450 | 452 | 455 | 451 | 451 |
| temperature (° C.) | | | | | | | |
| Intrinsic viscosity (dL/g) | 1.14 | 1.08 | 1.01 | 0.98 | 0.96 | 1.43 | 1.05 |
| Flowability (mm) | 130 | 138 | 140 | 132 | 134 | 130 | 141 |
| Strength retention rate | 93 | 91 | 90 | 91 | 90 | 94 | 89 |
| (%) | | | | | | | |
| water absorption rate | 0.8 | 0.7 | 0.7 | 0.8 | 0.8 | 0.7 | 0.9 |
| (%) | | | | | | | |
| Brightness (L*) | 95 | 95 | 96 | 93 | 93 | 95 | 92 |

As shown in Table 1, it was found that the polyamide of the present invention has excellent processability, water absorptivity and brightness (L*).

TABLE 2

| | Comparative Example | | | | | |
|---|---|---|---|---|---|---|
| | 1 | 2 | 3 | 4 | 5 | 6 |
| Melting temperature | 316 | 278 | 290 | 311 | 298 | 293 |
| (° C.) | | | | | | |
| Crystallization | 288 | 250 | 256 | 272 | 269 | 266 |
| temperature (° C.) | | | | | | |
| Thermal degradation | 450 | 444 | 451 | 453 | 443 | 451 |
| temperature (° C.) | | | | | | |
| Intrinsic viscosity | 1.3 | 0.6 | 0.62 | 0.93 | 0.84 | 0.88 |
| (dL/g) | | | | | | |
| Flowability (mm) | 92 | 140 | 93 | 88 | 91 | 87 |
| Strength retention | 88 | 85 | 84 | 85 | 86 | 88 |
| rate (%) | | | | | | |
| water absorption | 1.8 | 0.7 | 1.5 | 2.8 | 2.5 | 2.5 |
| rate (%) | | | | | | |
| Brightness (L*) | 90 | 95 | 88 | 82 | 85 | 87 |

As shown in Table 2, Comparative Example 1 which did not include the (a2) second aliphatic diamine monomer generally exhibits low flowability, strength retention rate and brightness, and excessively high water absorptivity. Further, Comparative Example 2 which included an excess of 1,12-dodecanediamine exhibits reduced melting temperature and low strength retention rate. Comparative Example 3 in which the total mole ratio of diamine and dicarboxylic acid is outside of the range of the present invention exhibits poor flowability and generally bad strength retention rate, water absorptivity and brightness. Even though two kinds of aliphatic diamines are employed, in the case of combining C6 aliphatic diamine with a C10 aliphatic diamine (Comparative Example 4), in the case of combining a C9 aliphatic diamine with a C10 aliphatic diamine (Comparative Example 5), and in the case of combining a C10 aliphatic diamine with a C11 aliphatic diamine (Comparative Example 6), flowability, strength retention rate, water absorptivity and brightness decrease. Specifically, Comparative Example 5 exhibits significantly increased water absorptivity. Accordingly, it can be noted that although two kinds of aliphatic diamines are employed, there can be a quite difference in terms of balance between flowability, strength retention rate, water absorptivity, heat resistance and brightness depending on the combination of carbon atoms of the amine components.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A polyamide resin comprising a polymer of (A) an aliphatic diamine and (B) a dicarboxylic acid,
wherein the (A) aliphatic diamine comprises (a1) a first aliphatic diamine monomer comprising a C4, C6, C8, or C10 aliphatic diamine or a combination thereof and (a2) a second aliphatic diamine monomer comprising a C12, C14, C16 or C18 aliphatic diamine or a combination thereof.

2. The polyamide resin according to claim 1, wherein the (a2) second aliphatic diamine monomer is present in an amount of about 0.1 mol % to about 70 mol % based on the total mol % of the diamine monomers of the aliphatic diamine (A).

3. The polyamide resin according to claim 1, wherein the (a2) second aliphatic diamine monomer is present in an amount of about 2 mol % to about 50 mol % based on the total mol % of the aliphatic diamine monomers of the aliphatic diamine (A).

4. The polyamide resin according to claim 1, wherein a mole ratio of the total mole of the (a1) first aliphatic diamine monomer and the (a2) second aliphatic diamine monomer to the total mole of the (B) dicarboxylic acid monomer, (a1+a2)/(B), ranges from about 0.90 to about 1.30.

5. The polyamide resin according to claim 1, wherein the (a1) first aliphatic diamine monomer is 1,10-decanediamine, and the (a2) second aliphatic diamine monomer is 1,12-dodecanediamine.

6. The polyamide resin according to claim 1, wherein at least one of the (a1) first aliphatic diamine monomer and the (a2) second aliphatic diamine monomer comprises a branched alkyl group.

7. The polyamide resin according to claim 1, wherein both the (a1) first aliphatic diamine monomer and the (a2) second aliphatic diamine monomer comprise a linear alkyl group.

8. The polyamide resin according to claim 1, wherein the (B) dicarboxylic acid comprises terephthalic acid, isophthalic acid, 2,6-naphthalene dicarboxylic acid, 2,7-naphthalene dicarboxylic acid, 1,4-naphthalene dicarboxylic acid, 1,4-phenylene dioxyphenylene acid, 1,3-phenylenedioxy-diacetic acid, diphenic acid, 4,4′-oxybis(benzoic acid), diphenylmethane-4,4′-dicarboxylic acid, diphenylsulfone-4,4′dicarboxylic acid, 4,4′-diphenylcarboxylic acid, or a combination thereof

9. The polyamide resin according to claim 1, wherein the (B) dicarboxylic acid is a mixture of an aromatic dicarboxylic acid and an aliphatic dicarboxylic acid.

10. The polyamide resin according to claim 1, wherein the polyamide resin has an end group capped with an end capping agent selected from the group consisting of aliphatic carboxylic acids, aromatic carboxylic acids, and combinations thereof

11. The polyamide resin according to claim 10, wherein the end capping agent comprises acetic acid, propionic acid, butyric acid, valeric acid, caproic acid, caprilic acid, lauric acid, tridecanoic acid, myristic acid, palmitic acid, stearic acid, pivalic acid, isobutyric acid, benzoic acid, toluic acid, a-naphthalene carboxylic acid, β-naphthalene carboxylic acid, methylnaphthalene carboxylic acid or a combination thereof.

12. The polyamide resin according to claim 1, wherein the polyamide resin has an intrinsic viscosity at 25° C. of about 0.3 dL/g to about 4.0 dL/g in 98% sulfuric acid solution at 25° C. as measured using an Ubbelohde viscometer.

13. The polyamide resin according to claim 1, wherein a ratio of tensile strength of the polyamide resin after treatment at 80° C. and 95% RH for 24 hours to tensile strength thereof before treatment at 80° C. and 95% RH for 24 hours is about 89% or more, and a water absorption rate of the polyamide resin after treatment at 80° C. and 80% RH for 48 hours is about 0.9% or less.

14. An LED reflector produced from the polyamide resin according to claim 1.
